(19) United States
(12) Patent Application Publication
(10) Pub. No.: US 2022/0206184 A1
(43) Pub. Date: Jun. 30, 2022

(54) INTEGRATED ROCK MECHANICS LABORATORY FOR PREDICTING STRESS-STRAIN BEHAVIOR

(71) Applicant: Landmark Graphics Corporation, Houston, TX (US)

(72) Inventors: Amit Kumar, Houston, TX (US); Hazim H. Abass, Pearland, TX (US); Ronald Glen Dusterhoft, Katy, TX (US)

(21) Appl. No.: 17/594,813

(22) PCT Filed: Aug. 12, 2019
(86) PCT No.: PCT/US2019/046237

§ 371 Date: Oct. 29, 2021

(51) Int. Cl. G01V 99/00; G06F 30/20

(52) U.S. Cl. CPC G01V 99/005; G06F 2119/14; G06F 30/20

(57) ABSTRACT

Partially coupling a geomechanical simulation with a reservoir simulation facilitates predicting strain behavior for a reservoir from production and injection processes. A method comprises generating a geomechanical model based on a mechanical earth model that represents a subsurface area. The geomechanical model indicates a division of the mechanical earth model into a plurality of grid cells that each correspond to a different volume of the subsurface area. Based on a first virtual compaction experiment with the geomechanical model, compaction curves are generated. The compaction curves represent porosity as a function of stress. The compaction curves are converted from porosity as a function of stress to porosity as a function of pore pressure. The geomechanical model is partially coupled to a reservoir simulation model using the converted compaction curves.

### TECHNICAL FIELD

The disclosure generally relates to the field of data processing, and more particularly to modeling, design, simulation, or emulation.

### BACKGROUND ART

Theoretical models can be used to predict or correlate specific physical properties of porous rock. Most theoretical models are built on simplified concepts related to properties associated with an ideal porous rock. One such theoretical model is a traditional reservoir simulation where rock mechanics are accounted for by use of a time-invariant compressibility factor. This method of reservoir simulation is useful when rock in a reservoir behaves elastically and the effects of coupled rock mechanics in the reservoir can be ignored. However, during production and injection processes, rock properties do not behave elastically and cannot be treated by an ideal approximation.

To better simulate the rock mechanics in a reservoir during production and injection processes, geomechanical properties, such as fluid flow, can be coupled to the reservoir simulation. Typically, rock mechanics are coupled to fluid flow through porosity and permeability. Porosity changes are a direct result of deformation of the matrix, or solid rock, which is a function of both stress and pressure. Permeability is a function the effective stress on a reservoir. Coupled geomechanical and reservoir simulation modeling solves simultaneously for fluid flow and stress in a reservoir. The results of such simulations are used to determine production levels at a specific point in a reservoir.

### BRIEF DESCRIPTION OF THE DRAWINGS

Embodiments of the disclosure may be better understood by referencing the accompanying drawings.

FIG. 1 depicts a schematic diagram of the process of partial coupling of geomechanics and reservoir simulation.

FIG. 2 depicts a flowchart of operations for predicting stress-strain behavior during production and injection processes using an integrated rock mechanics virtual laboratory.

FIG. 3 depicts an example of a grid generated from a mechanical earth model suitable for use in coupled geomechanical reservoir simulation.

FIG. 4 depicts a flowchart of operations for creating a mechanical earth model.

FIG. 5 depicts a flowchart of operations to generate compaction curves and calibrate the generated compaction curves through virtual or lab experiments.

FIG. 6 depicts a flowchart of operations for coupling the geomechanical model to the reservoir simulation model and analyzing the coupled simulation results.

FIG. 7 depicts an example of a simulated output result.

FIG. 8 depicts an example computer, according to some embodiments.

### DESCRIPTION OF EMBODIMENTS

The description that follows includes example systems, methods, techniques, and program flows that embody embodiments of the disclosure. However, it is understood that this disclosure may be practiced without these specific details. For instance, this disclosure refers to predicting deformation during production and injection processes using compaction curves generated through a virtual lab in illustrative examples. Aspects of this disclosure can also be applied to predict deformation during production and injection processes using other sets of calibrated correlations such as elastic and plastic properties, porosity, permeability, and natural fracture conductivities, all as function of effective stress. In other instances, well-known instruction instances, protocols, structures and techniques have not been shown in detail in order not to obfuscate the description.

### OVERVIEW

Predicting production and injection processes is often performed through reservoir simulators. Coupling reservoir and geomechanical simulation allows for better prediction. There are multiple coupling techniques that can be used to combine reservoir simulation with geomechanical simulation. Full coupling involves both simulations running in tandem inside one large matrix. The systems of equations for each simulation are solved simultaneously. This creates a slow process that is computationally expensive. To reduce time and computation requirements, partial coupling of geomechanical and reservoir simulations can be employed. In partial coupling methods, compaction curves can be used as inputs for the reservoir simulator. Traditionally, these compaction curves are arbitrary approximations used as a tuning parameter in the reservoir simulation. Traditional compaction curves used as inputs in reservoir simulations are not generated using geomechanical software but are instead adjusted and matched to historical data. The compaction tables generated from the compaction curves are manually changed so the output of the reservoir simulation matches historical data. This causes a large uncertainty in the output as the adjusted data is not validated.

Accordingly, a technique has been developed for numerically computing a compaction curve that can be used inside a traditional reservoir simulator. This technique uses partial coupling to allow for faster and less computationally expensive results while providing input data to the reservoir simulator that is accurate and faithful to geomechanical processes. Unlike traditional compaction tables that use history matching, the generated compaction tables have a physical basis since they are generated through geomechanical processes. The generated compaction tables allow for a higher quality, more predictive output from the reservoir simulator.

To numerically compute compaction curves that can be used inside a traditional reservoir simulator without stress or strain calculations, an integrated rock mechanics virtual laboratory (virtual lab) can be used to generate compaction tables. A mechanical earth model is used to generate compaction curves. The mechanical earth model is a geologic model that represents the known structure of the subsurface in an area. The mechanical earth model uses well log data to generate a virtual compaction experiment, rock lab experiments to populate the mechanical earth model, and nano-imaging techniques to identify the mineral composition and concentrations of minerals in rock samples. Unlike traditional earth models for oil exploration and production, mechanical earth (geomechanical) models account for the overburden rock in the mechanical earth model. From the created mechanical earth model, a grid is generated for geomechanical calculations.

Converting compaction curves into inputs a reservoir simulation can use provides a link between geomechanical models and the reservoir simulation. Providing this link allows for a more expansive representation of the reservoir than current coupling techniques which tend to represent point solutions of the reservoir. This removes inconsistencies in various parts of the simulated reservoir and utilizes the benefits of geomechanics.

### EXAMPLE ILLUSTRATIONS

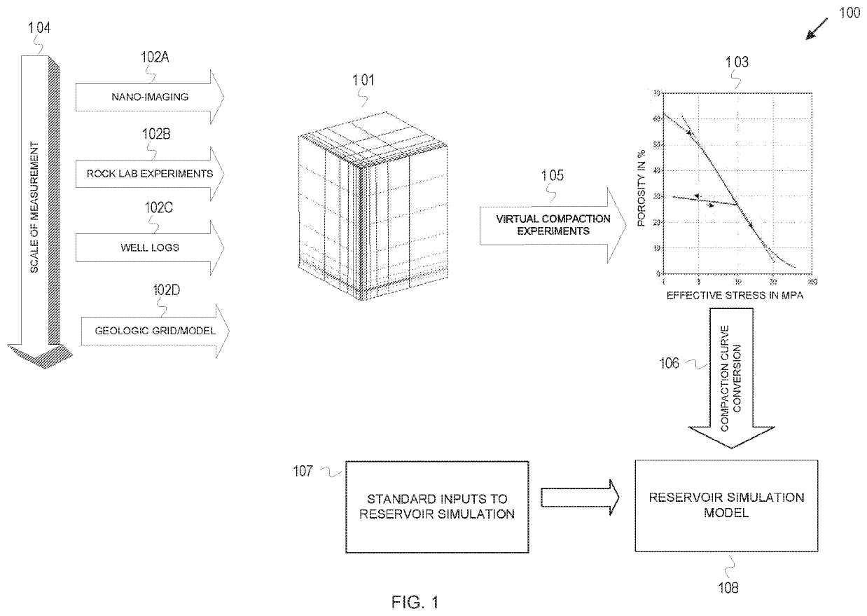

FIG. 1 depicts a schematic diagram of the process of partial coupling of geomechanics and reservoir simulation. FIG. 1 provides a visual summary of the process of generating compaction curves using a geomechanical model for use in a reservoir simulation model. In diagram 100, the geomechanical model 101 is generated by constructing a grid to divide a mechanical earth model that is created using a combination of inputs. Those inputs include nano-imaging (102A), rock lab experiments (102B), well logs (102C), and geologic grids/models (102D). Each of these inputs varies in scale, as indicated by arrow 104. Nano-imaging techniques generate nano-imaging inputs (102A) on the nanometer range while geologic grids/models (102D) can represent areas spanning a kilometer or more. Thus, the geomechanical model 101 is well populated to represent the earth across a wide variety of scales and input types.

The geomechanical model is run through virtual compaction experiments 105 to generate compaction curves 103. Compaction curves 103 are generated through virtual or lab experiments using the geomechanical model 101. Finite element models of the geomechanical model 101 are used to simulate the process of compaction and the associated compaction curve. Compaction curve conversion 106 converts the compaction curve 103 from porosity as a function of effective stress to porosity as a function of pore pressure.

Traditional reservoir simulators use finite difference models, as opposed to the finite element models used in geomechanical simulators. In finite element models, stress and strain are incorporated in the inputs and outputs. In a finite difference model, pressure and fluid saturation data are incorporated, and stress is neither an input nor an output. Compaction curve conversion 106 converts the compaction curve 103 into a form that considers the stress behavior in a reservoir. Converting the compaction curve from porosity as a function of stress to porosity as a function of pressure allows the reservoir simulation model 108 to use the compaction curve 103 as a look up table, or data input, without solving for stress and/or strain data since reservoir simulators can input and output pressure data.

Multiple compaction curves 103 are generated for various regions of the geologic model. A lab experiment with soil or core of a subsurface area corresponding to the mechanical earth model can be performed to calibrate data from a virtual compaction experiment. This helps validate assumptions on the constitutive laws applicable to specific areas of the mechanical earth model. Porous components are calibrated separately. The geomechanical model is partially coupled to the reservoir simulation model 108. The compaction curves 103, along with standard inputs for reservoir simulations 107, are used as inputs to create the reservoir simulation model 108. The compaction curves 103 provide the reservoir simulation model 108 with information relating to pore pressure converted from stress. The compaction curves 103 with porosity (and/or permeability) as a function of pore pressure are used as look up tables or other standard inputs in the reservoir simulation model 108. The results of the partially coupled geomechanical and reservoir simulators are used for prediction of deformation during production and injection processes without needing to first solve for stress and/or strain changes in reservoir simulations.

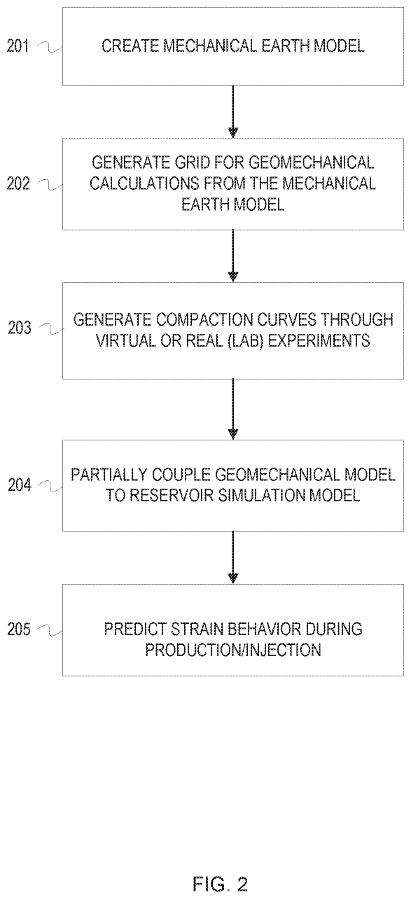

FIGS. 2 and 4-6 depict flowcharts of example operations for predicting stress-strain behavior during production and injection using an integrated rock mechanics virtual laboratory. FIGS. 2 and 4-6 include operations that can be performed by hardware, software, firmware, or a combination thereof. For example, at least some of the operations can be performed by a processor executing program code or instructions.

FIG. 2 depicts a flowchart of operations for predicting stress-strain behavior during production and/or injection using an integrated rock mechanics virtual laboratory. Operations of the flowchart start at block 201.

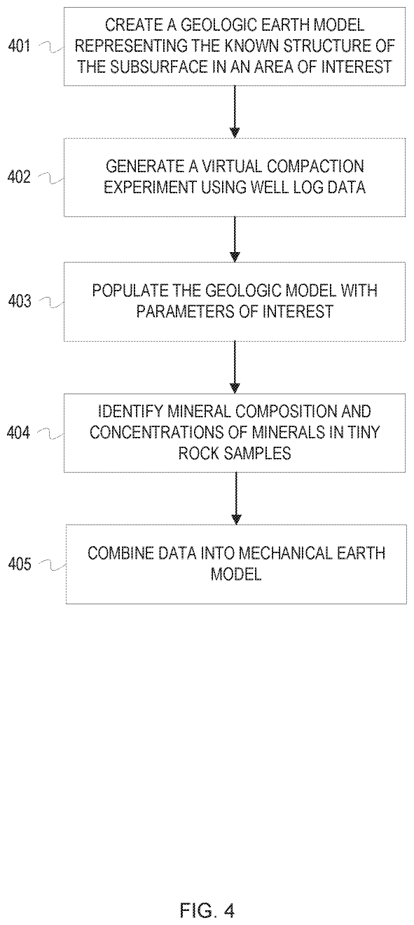

At block 201, a mechanical earth model is created. The mechanical earth model is a numerical representation of the geomechanical state of the reservoir. The mechanical earth model is linked to the geologic structure of the reservoir through local stratigraphy, well log information, core information and seismic data. The mechanical earth model incorporates data about rock property distribution and fracture systems in the reservoir as well as pore pressure, state of stress, and rock mechanical properties. Stress on the reservoir is caused by overburden weight, any superimposed tectonic forces, and by production and injection. Properties of the mechanical earth model are mapped to a grid for further analysis. Further details of creating a mechanical earth model are described in FIG. 4.

At block 202, a suitable grid for geomechanical calculations is generated from the mechanical earth model. The mechanical earth model is a numerical or a data representation of the physical geomechanics of the reservoir. A grid is constructed to perform numerical analysis on the mechanical earth model. The grid subdivides the larger mechanical earth model into smaller finite elements, or grid cells. Each grid cell represents a smaller volume of the mechanical earth model to allow for simplified numerical analysis or geomechanical calculation. While the size of the grid cells is adjusted to fit the data and numerical analysis method, thus changing the data associated with each specific grid cell, changing the grid pattern does not change the physical representation of the data of the mechanical earth model. A suitable grid takes into account attributes of the mechanical earth model to determine grid pattern and sizing. For example, a grid suitable for the geomechanical calculations would be generated based on size, geometry, and complexity of the mechanical earth model to determine the grid pattern and sizing. The grid generated from the mechanical earth model is adjusted to make the mechanical earth model suitable for geomechanical calculations. Such adjustments can include applying approximations to generate a grid with continuous triangular or square cells that can be solved with finite element analysis. The gridded mechanical earth model can also be referred to as a geomechanical model.

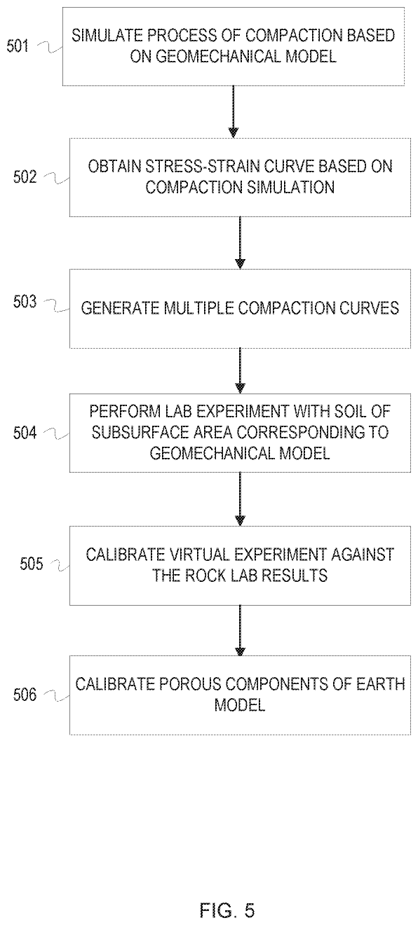

At block 203, compaction curves are generated through virtual and real (laboratory) experiments. The virtual lab is a set of calibrated correlations to predict deformation during production and injection processes. The virtual experiment is calibrated to match data from at least one well in a reservoir. If real laboratory experimental data is available, it can be used to validate the geomechanical calculations corresponding to the point where the sample was taken from. With multiple validation points calibrated to experimental data, the geomechanical model becomes a more accurate predictive tool over a wide range of rock properties that represent the reservoir. Compaction curves are one relationship generated through the virtual lab. Further details of the virtual experiment and the process of generating compaction curves are described in FIG. 5.

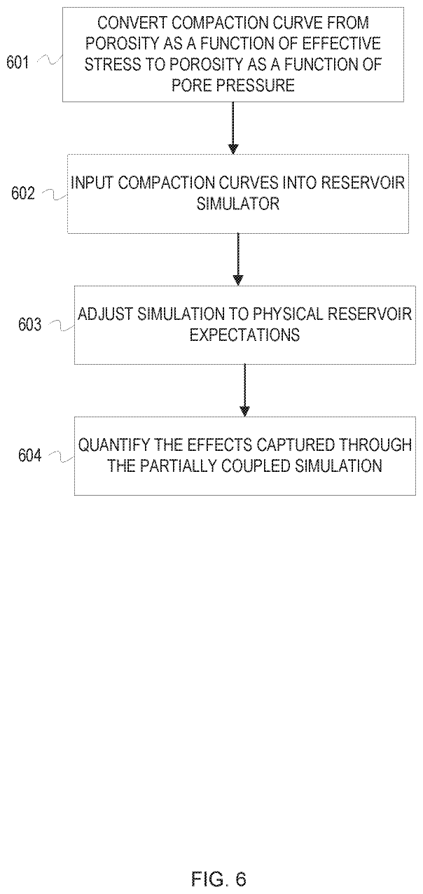

At block 204, the geomechanical model is coupled to a reservoir simulation model. The compaction curves are transformed and used as inputs for the reservoir simulator. Information can be exchanged between the reservoir simulator and the geomechanical model using a partially coupled approach. Further details of the coupling of the models are described in FIG. 6.

At block 205, strain behavior is predicted for production and injection processes. The calibrated virtual lab results can be used to predict stress strain behavior across multiple wells. Once the virtual lab is calibrated, the logs can be used to predict strain behavior during production and injection processes for other wells using a commercial reservoir simulator.

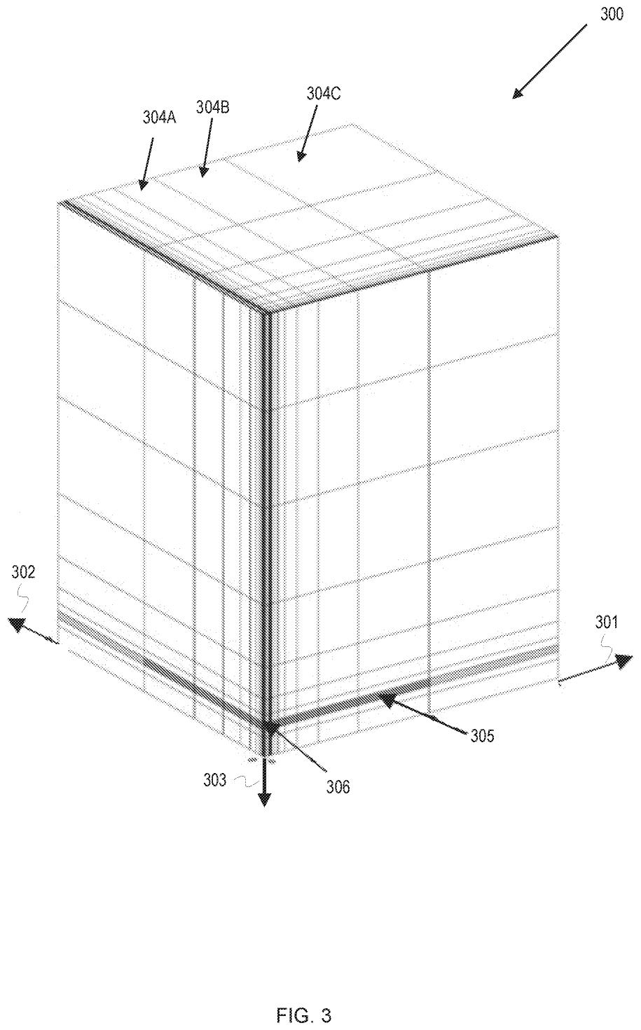

FIG. 3 depicts an example of a grid generated from a mechanical earth model suitable for use in a coupled geomechanical reservoir simulation. Grid 300 is a three-dimensional grid overlaying the mechanical earth model representing the geomechanical state of a reservoir. Grid 300 has an x-axis 301 and a y-axis 302 representing the horizontal plane in the reservoir. Z-axis 303 represents depth below the surface of the earth. Grid cells, such as cell 304A, 304B, and 304C (collectively referred to as 304), subdivide the mechanical earth model which contains information pertaining to rock property distribution, pore pressures, and state of stress of a reservoir. Thus, each grid cell represents a volume of the mechanical earth model and the properties associated with that volume. The stresses on a reservoir are caused by the overburden weight, any superimposed tectonic forces, and production and injection. Grid cells 304 vary in size to represent the complexity of a reservoir and the earth formation surrounding the reservoir. Smaller cells, such as cell 304A, represent dense areas of data in the mechanical earth model while larger cells, such as cell 304C, represent less complex areas of a formation in the mechanical earth model. Reservoir 305 is depicted as a horizontal layer. This allows the model to predict overburden weight through properties associated with the mechanical earth model in the grid cells 304 above the reservoir 305. Fractures, such as fracture 306, are represented in the grid 300. As an example, fracture 306 represents a fracture in the x-direction. Coupled geomechanical and reservoir simulation can use grids generated from mechanical earth models, such as grid 300, for calculation of compaction tables to be used as inputs in a reservoir simulator.

FIG. 4 depicts a flowchart of example operations for creating a mechanical earth model, as in block 201 of FIG. 2.

At block 401, a geologic earth model is created. The geologic earth model (or geologic model) is a spatial representation of the distribution of sediments and rocks in a subsurface area of interest. The geologic earth model can be used for a computerized visualization of the known structure of the substance in the subsurface area of interest. Standard geologic modeling practices can be applied to create the geologic earth model. These practices include basin modeling, seismic interpretation, and horizons and faults tuned to known, measured, or estimated data. The geologic earth model can be a detailed or simplified model. Overburden effect is included in the geologic earth model.

At block 402, a virtual compaction experiment (also referred to herein as simulated compaction or virtual experiment) is performed using well log data. The virtual compaction experiment simulates the forces acting on a rock sample to determine the stress and/or strain the rock sample can endure before breaking. Known properties of the geologic model obtained from the well log data are input into the virtual compaction experiment to determine the stress and/or strain acting on a sample portion of the geologic model. From the virtual compaction experiment on a rock sample, values for mass densities, elastic moduli, and Poisson's ratio are calculated for the specific rock sample. Known data from well logs can also be incorporated in the geologic model through geostatistical methods.

An example of a virtual compaction experiment is a uniaxial compression simulation. The true strain, or change in length with respect to the instant length, is used to determine the duration of the experiment. The duration of the experiment is selected such that the true strain of −1 is reached at the end of the virtual experiment. The uniaxial compaction experiment is just one type of experiment that may be used. Multiaxial or other known compression experiments can also be used.

At block 403, the geologic model is populated with parameters of interest. The parameters of interest are obtained from rock lab experiments on cores taken from at least one well. Cores can be side-wall cores. Larger, whole cores can also be used. Cores from multiple wells may be incorporated into the mechanical earth model as well. The parameters of interest are used to tune and/or calibrate the virtual compaction experiment.

At block 404, mineral composition and concentrations of minerals in tiny rock samples are identified using nano-scale imaging techniques. Mineral data is used to determine values for specific geomechanical parameters of interest. This allows for the geologic model to account for properties of the subsurface are at difference scales of size.

At block 405, the data obtained in blocks 401-404 is combined to create a mechanical earth model. The mechanical earth model is a repository of data from the measurements and models of blocks 401-404. The mechanical earth model numerically combines the spatial representation of the geologic model with the measurements obtained from the compaction experiment and the mineral composition and concentrations obtained from nano-imaging to populate the mechanical earth model.

FIG. 5 depicts a flowchart of example operations to generate compaction curves and calibrate the generated compaction curves through virtual and lab experiments. These example operations correspond with block 203 of FIG. 2.

At block 501, a virtual experiment or compaction simulation is performed to obtain information for generating the compaction curves. The virtual experiment is similar to the virtual compaction experiment of block 402 of FIG. 4 but is performed on the geologic scale over the entire field of the mechanical earth model. So, this virtual experiment performed to obtain compaction curve information simulates the overall behavior of the modeled subsurface area of interest. This includes the compaction behavior of rocks and soils, as in the virtual compaction experiment of block 402, as well as the compaction behavior of cracks and fractures in a region(s) of the mechanical earth model. To perform the compaction simulation, the gridded mechanical earth model, or geomechanical model, is utilized. For instance, the mechanical earth model can be divided into a grid of finite elements for use with Finite Element Modeling (FEM) using a partial or full extent of the mechanical earth model. Virtual compaction experiments are performed on each grid cell. Inputs to FEM include geometry of a sample (length, diameter), mass density, elastic modulus, and/or Poisson's ratio. The power law relationship is assumed to be equivalent between plastic strain and equivalent stress.

At block 502, a stress-strain curve is obtained based on the compaction simulation. After the simulation occurs over the selected duration, a force-displacement curve is extracted from the simulation data. Based on the force-displacement curve, an engineering stress-engineering strain curve is calculated, which is a normalized model assuming a fixed area. The engineering stress-engineering strain curve is then used to calculate a true stress-strain curve for the area corresponding to the compaction simulation. The stress-strain curve includes the effect of increasing or decreasing effective stress. The stress information in the stress-strain curve combined with the known porosity (and/or permeability) of the region of interest being compacted are used to create compaction curves representing porosity as a function of stress.

At block 503, multiple compaction curves are generated for various regions of the geomechanical model. For a given sample of soil, compaction involving different compactive energy or effort results in shifted curves of similar shape. For example, the curve moves up and to the left on a plot when the applied compactive effort increases. Generating multiple compaction curves in various regions of the geomechanical model by simulating different compactive efforts creates a family of compaction curves that represent the geomechanical model across a range of simulated compactive efforts.

At block 504, a rock lab (real) experiment is performed with soil or core of a subsurface area or reservoir corresponding to the mechanical earth model. A typical rock lab experiment that can be performed is a standard Proctor test. During the experiment, soil is compacted in a mold. The soil is mixed with varying amounts of water and then compacted in three equal layers. The weight of the mold with the compacted moist soil is measured. A sample of the moist soil is extracted from the mold to determine moisture content. After collecting the weight of the moist soil, the dry density of the soil is calculated. The graphical relationship of the dry density to moisture content is plotted to establish a compaction curve. While the standard Proctor test is an example of a rock lab experiment that can be performed, other types of rock lab experiments, such as a modified Proctor test or a gyratory compaction test, may also be used. Similar testing procedures can be completed using intact core material recovered from the reservoir using a triaxial test fixture and recording the change in volume as a function of stress and then determining the corresponding change in porosity. Compaction tests such as these are routinely performed on cores coming from relatively weak formations that are subject to mechanical failure under production conditions, often requiring the use of sand control completions to prevent the influx of failed formation material into the wellbore during production operations.

At block 505, the virtual experiment is calibrated against the rock lab results. The calibration validates assumptions of the constitutive laws applicable to specific areas of the geologic model. For example, split core and conductivity in real rock experimental methods can be useful for calibration. Split core experimentation is best suited for unsupported factures, micropropants, and closure on effective permeability. Conductivity in real rock experiments use local rock properties from lab testing and/or correlations available or developed from experiments on available rock samples.

At block 506, porous components of the geomechanical model are calibrated. Porous components can include the rock matrix, natural fractures, and bedding planes. Calibration of each component is performed separately since different sets of tuning data have unique behavior characteristics. For example, separate poro-elastic coefficients are assigned to the porous components for calibration.

FIG. 6 depicts a flowchart of example operations for coupling the geomechanical model to the reservoir simulation model and analyzing the coupled simulation results. These example operations correspond with block 204 of FIG. 2.

At block 601, compaction curves are converted from porosity (and/or permeability) as a function of effective stress to porosity (and/or permeability) as a function of pore pressure. The compaction curves can be converted by taking advantage of the relationship between the variables as captured in Equation (1):

$${σ}_{p}^{′} = \frac{v}{1 - v} {σ}_{v} + ( α ( 1 - \frac{v}{1 - v} ) - {α}_{p} ) p + E ϵ \qquad ( 1 )$$

where σₚ′ is the effective stress, α is Biot's constant, αₚ is Biot's constant for the soil type, p is the pressure, σᵥ is overburden stress, ν is Poisson's ratio, E is young's modulus, and ε is strain. For example, with the values of:

$$v = \frac{1}{4} and α = {α}_{p} = 1$$

Equation (1) yields the following relationship:

$${σ}_{p}^{′} = \frac{1}{3} {σ}_{v} - \frac{1}{3} p + E ϵ . \qquad ( 2 )$$

The relationship in Equation (2) shows that effective stress and pore pressure are inversely proportional. This relationship allows compaction curves to be converted from porosity as a function of effective stress to porosity as a function of pore pressure.
At block 602, the compaction curves are input into the reservoir simulator. The reservoir simulator processes the converted compaction curves and can account for changes in relative permeability due to the change in porosity and the fluid saturations present within the reservoir. In some cases, reservoir compaction can help maintain pressure stability in the reservoir. The pore pressure within the rock is maintained by the shifting or failure of rock grains allowing the pore volume to be compacted by the overburden weight during production. The compaction forces fluid out of the reservoir until the pressure is stabilized and further compaction cannot easily occur. In cases like this, the bulk volume water within the rock will often remain constant because it is the wetting surface on the rock face. In these cases, the relative fluid saturations will change as the reservoir is compacted and the relative permeability will therefore also change significantly as water saturation tends to increase and oil saturation tends to decrease. Changes in the relative permeability curves can be calculated and implemented by the reservoir simulator through the converted compaction curves for permeability as a function of pore pressure to account for these complex effects. The converted compaction curves are used as look-up tables or other standard inputs for the reservoir simulator. This allows the reservoir simulator to run without first manually solving for stress and/or strain data.

At block 603, the reservoir simulation is adjusted to match physical reservoir expectations. The compaction curves are adjusted based on the stress changes during the simulated period for which conversion between stress and pore-pressure occurred. An unstructured grid or an approximation of dual continuum can be used to fully capture the geometry of the natural and hydraulic fractures.

At block 604, the effects captured through the partially coupled simulation are interpreted or quantified. The quantified effects are used to analyze reservoir properties. Different porous components in the reservoir simulation are quantified separately. Separate calibration of porous components allows each component to be treated individually when analyzing the reservoir properties. For example, depletion of reservoir pressure can significantly distort the regional stress field. The partially coupled simulators capture this effect. In ultralow permeability reservoirs, the partial coupling methodology described herein quantifies the effect of interference between two or more horizontal wells. The effect of the sequence and timing of drilling infill wells can also be quantified using the partial coupling method.

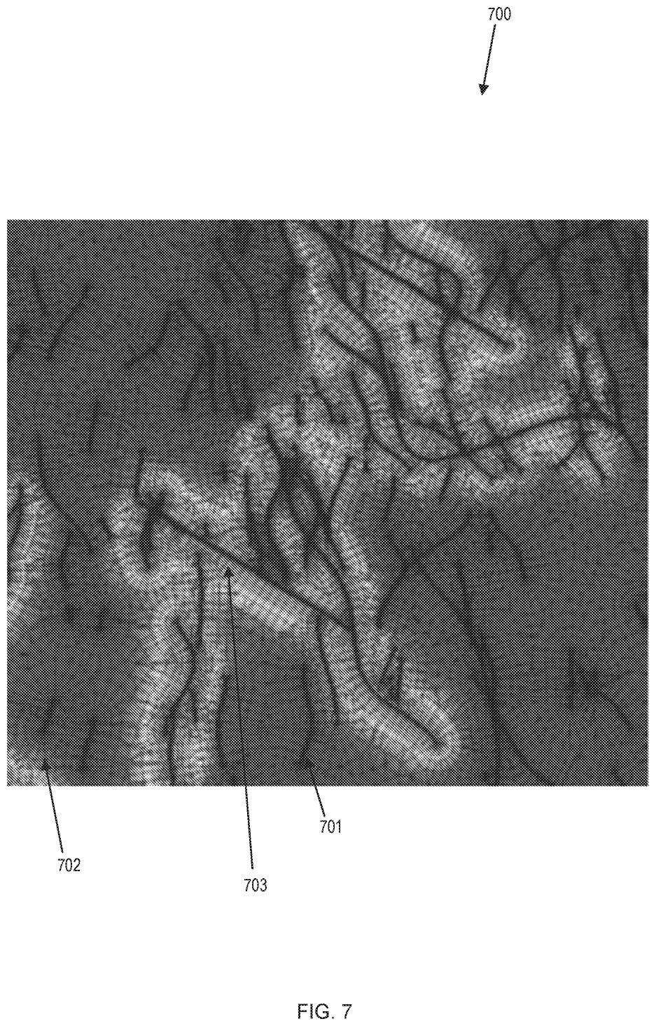

FIG. 7 depicts an example of a simulated output result. Output 700 shows a simulation result of flow with fracture geometry explicitly gridded into an unstructured grid. Output 700 is a prediction of pressure in a reservoir around a well as predicted by the simulator. Grid lines (such as grid line 702) represent an unstructured geometry around fractures (such as fracture 701). A well 703 runs diagonally along a portion of the reservoir. The shading represents various pressure levels with lighter colors representing low pressure and darker colors representing higher pressures. Output 700 predicts lower pressure in the areas adjacent to the well 703. Fractures connected, or in close proximity, to the well 703 also experience a pressure loss. Fractures further away from the well 703 are not impacted by the well 703 and do not exhibit the same pressure loss.

### Variations

While FIGS. 1-7 depict example embodiments of methods for partially coupling geomechanical and reservoir simulators, variations upon these methods may be applied without changing the scope of the technology. Various elements can be used by themselves or in combination with the basic embodiments shown above. For example, tuning and/or calibrating of the compaction curves can be based on rock lab results. This could be used in combination with the operations of FIG. 5. As another example variation, validation of nano-imaging can be done with rock lab results by upscaling nano-imaging data to core scale. Further variation includes history matching of the coupled reservoir model with geomechanical parameters which can be used in combination with the operations of FIG. 5.

### Example System

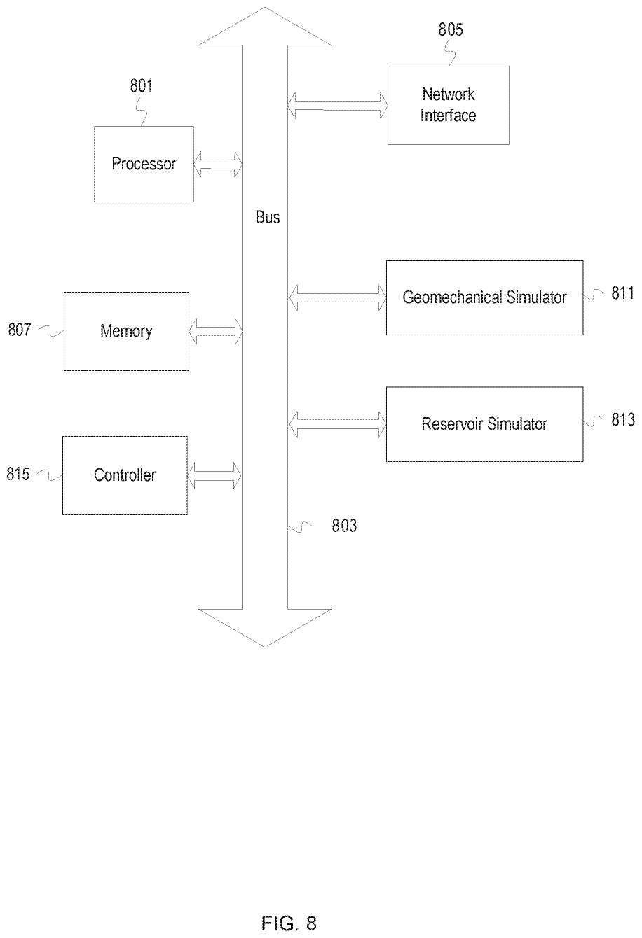

FIG. 8 depicts an example system that partially couples a geomechanical model or mechanical earth model with a reservoir simulation model. The system includes a processor 801 (possibly including multiple processors, multiple cores, multiple nodes, and/or implementing multi-threading, etc.). The system includes memory 807. The memory 807 may be system memory or any one or more of the above already described possible realizations of machine-readable media. The system also includes a bus 803 and a network interface 805.

The system also includes a geomechanical simulator 811 and a reservoir simulator 813. The simulator 811 can perform operation of geomechanical simulations, as described above. The reservoir simulator 813 can perform operations of reservoir simulations, as described above. The controller 815 can control the different operations that can occur in the response to results from the simulations. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java@ programming language, C++ or the like; a dynamic programming language such as Python: a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set (A, B, C) or any combination thereof, including multiples of any element.

### EXAMPLE EMBODIMENTS

Example embodiments include the following:

A method comprises generating a geomechanical model based on a mechanical earth model that represents a subsurface area. The geomechanical model indicates a division of the mechanical earth model into a plurality of grid cells that each correspond to a different volume of the subsurface area. Based on a first virtual compaction experiment with the geomechanical model, compaction curves are generated. The compaction curves represent porosity as a function of stress. The compaction curves are converted from porosity as a function of stress to porosity as a function of pore pressure. The geomechanical model is partially coupled to a reservoir simulation model using the converted compaction curves.

Partially coupling the geomechanical model to the reservoir simulation model using the converted compaction curves comprises providing the converted compaction curves as input to the reservoir simulation model.

Generating the compaction curves comprises generating one or more compaction curves for different ones of the grid cells.

The method further comprises calibrating results from the first virtual compaction experiment against rock lab results.

The method further comprises creating the mechanical earth model. Creating the mechanical earth model comprises performing a second virtual compaction experiment with rock and/or soil data of the subsurface area. The mechanical earth model is created with data corresponding to different geologic scales for the subsurface area. Data of different geologic scales comprises data from well logs, rock lab experiments on rock cores, and nano-imaging techniques.

The method further comprises predicting strain behavior for the subsurface area during production and injection processes using results from the reservoir simulation model after the partial coupling.

Generating the compaction curves comprises generating the compaction curves based, at least in part, on a true stress-strain curve that is based on information generated from the first virtual compaction experiment. Generating the compaction curves further comprises extracting a force-displacement curve from the information generated from the first virtual compaction experiment. The true stress-strain curve is based, at least in part, on the force-displacement curve. An engineering stress-strain curve is calculated from the force-displacement curve. The true stress-strain curve is calculated based, at least in part, on the engineering stress-strain curve.

Converting the compaction curves is based, at least in part, on an inversely proportional relationship between stress and porosity.

One or more non-transitory machine-readable media comprises program code to generate a first plurality of compaction curves that represent porosity as a function of stress with compaction simulations on different cells of a geomechanical model that divides a mechanical earth model. The mechanical earth model represents a subsurface area at multiple geologic scales. The first plurality of compaction curves that represent porosity as a function of stress are converted to a second plurality of compaction curves that represent porosity as a function of pore pressure. The second plurality of compaction curves are input into to a reservoir simulation model to predict strain behavior for the subsurface area.

The program code further comprises instructions to generate the mechanical earth model with data of different geologic scales for the subsurface area.

The program code further comprises instructions to divide the mechanical earth model into grid cells to generate the geomechanical model.

The instructions to generate the first plurality of compaction curves comprise instructions to, for each of the compaction simulations, extract a force-displacement curve from results of the compaction simulation, calculate an engineering stress-strain curve from the force-displacement curve, and determine a true stress-strain curve from the engineering stress-strain curve. One or more of the first plurality of compaction curves for the cell corresponding to the compaction simulation is based on the true stress-strain curve.

The instructions to convert the first plurality of compaction curves to the second plurality of compaction curves are based, at least in part, on an inversely proportional relationship between stress and porosity.

An apparatus comprises a processor and a machine-readable medium having program code executable by the processor to cause the apparatus to generate a first plurality of compaction curves that represent porosity as a function of stress with compaction simulations on different cells of a geomechanical model that divides a mechanical earth model. The mechanical earth model represents a subsurface area at multiple geologic scales. The first plurality of compaction curves that represent porosity as a function of stress are converted to a second plurality of compaction curves that represent porosity as a function of pore pressure. The second plurality of compaction curves are input into a reservoir simulation model to predict strain behavior for the subsurface area.

The instructions to convert the first plurality of compaction curves to the second plurality of compaction curves comprise instructions to convert based on

$${σ}_{p}^{′} = \frac{v}{1 - v} {σ}_{v} + ( α ( 1 - \frac{v}{1 - v} ) - {α}_{p} ) p + E ϵ ,$$

wherein σₚ′ is effective stress, α is Biot's constant, αₚ is Biot's constant for a soil type, p is pressure, σᵥ is overburden stress, ν is Poisson's ratio, E is young's modulus, and ε is strain.

What is claimed is:

1. A method comprising:
generating a geomechanical model based on a mechanical earth model that represents a subsurface area, wherein the geomechanical model indicates a division of the mechanical earth model into a plurality of grid cells that each correspond to a different volume of the subsurface area;
based on a first virtual compaction experiment with the geomechanical model, generating compaction curves, wherein the compaction curves represent porosity as a function of stress;
converting the compaction curves from representing porosity as a function of stress to representing porosity as a function of pore pressure; and
partially coupling the geomechanical model to a reservoir simulation model using the converted compaction curves.

2. The method of claim 1, wherein partially coupling the geomechanical model to the reservoir simulation model using the converted compaction curves comprises providing the converted compaction curves as input to the reservoir simulation model.

3. The method of claim 1, wherein generating the compaction curves comprises generating one or more compaction curves for different ones of the grid cells.

4. The method of claim 1, further comprising calibrating results from the first virtual compaction experiment against rock lab results.

5. The method of claim 1, further comprising creating the mechanical earth model.

6. The method of claim 5, wherein creating the mechanical earth model comprises performing a second virtual compaction experiment with rock and/or soil data of the subsurface area.

7. The method of claim 5, wherein creating the mechanical earth model comprises creating the mechanical earth model with data corresponding to different geologic scales for the subsurface area.

8. The method of claim 7, wherein creating the mechanical earth model with data of different geologic scales comprises creating the mechanical earth model with data from well logs, rock lab experiments on rock cores, and nano-imaging techniques.

9. The method of claim 1, further comprising predicting strain behavior for the subsurface area during production and injection processes using results from the reservoir simulation model after the partial coupling.

10. The method of claim 1, wherein generating the compaction curves comprises generating the compaction curves based, at least in part, on a true stress-strain curve that is based on information generated from the first virtual compaction experiment.

11. The method of claim 10 further comprising extracting a force-displacement curve from the information generated from the first virtual compaction experiment, wherein the true stress-strain curve is based, at least in part, on the force-displacement curve.

12. The method of claim 11 further comprising calculating an engineering stress-strain curve from the force-displacement curve, wherein the true stress-strain curve is calculated based, at least in part, on the engineering stress-strain curve.

13. The method of claim 1, wherein converting the compaction curves is based, at least in part, on an inversely proportional relationship between stress and porosity.

14. One or more non-transitory machine-readable media having program code, the program code comprising instructions to:
generate a first plurality of compaction curves that represent porosity as a function of stress with compaction simulations on different cells of a geomechanical model that divides a mechanical earth model, wherein the mechanical earth model represents a subsurface area at multiple geologic scales;
convert the first plurality of compaction curves that represent porosity as a function of stress to a second plurality of compaction curves that represent porosity as a function of pore pressure; and
input the second plurality of compaction curves to a reservoir simulation model to predict strain behavior for the subsurface area.

15. The non-transitory machine-readable media of claim 14, wherein the program code further comprises instructions to:
generate the mechanical earth model with data of different geologic scales for the subsurface area.

16. The non-transitory machine-readable media of claim 15, wherein the program code further comprises instructions to divide the mechanical earth model into grid cells to generate the geomechanical model.

17. The non-transitory machine-readable media of claim 14, wherein the instructions to generate the first plurality of compaction curves comprise instructions to:
for each of the compaction simulations,
extract a force-displacement curve from results of the compaction simulation;
calculate an engineering stress-strain curve from the force-displacement curve; and
determine a true stress-strain curve from the engineering stress-strain curve, wherein one or more of the first plurality of compaction curves for the cell corresponding to the compaction simulation is based on the true stress-strain curve.

18. The non-transitory machine-readable media of claim 14, wherein the instructions to convert the first plurality of compaction curves to the second plurality of compaction curves are based, at least in part, on an inversely proportional relationship between stress and porosity.

19. An apparatus comprising:
a processor; and
a machine-readable medium having program code executable by the processor to cause the apparatus to,
generate a first plurality of compaction curves that represent porosity as a function of stress with compaction simulations on different cells of a geomechanical model that divides a mechanical earth model, wherein the mechanical earth model represents a subsurface area at multiple geologic scales;
convert the first plurality of compaction curves that represent porosity as a function of stress to a second plurality of compaction curves that represent porosity as a function of pore pressure; and
input the second plurality of compaction curves to a reservoir simulation model to predict strain behavior for the subsurface area.

20. The apparatus of claim 19, wherein the instructions to convert the first plurality of compaction curves to the second plurality of compaction curves comprise instructions to convert based on
$${σ}_{p}^{′} = \frac{v}{1 - v} {σ}_{v} + ( α ( 1 - \frac{v}{1 - v} ) - {α}_{p} ) p + E ϵ$$
wherein σₚ′ is effective stress, α is Biot's constant, αₚ is Biot's constant for a soil type, p is pressure, σᵥ is overburden stress, v is Poisson's ratio, E is young's modulus, and ε is strain.
